(19) United States
(12) Patent Application Publication
(10) Pub. No.: US 2002/0075593 A1
(43) Pub. Date: Jun. 20, 2002

(54) Self adjusting GMR proximity recording ABS feature

(76) Inventors: Thomas P. Ultican, San Diego, CA (US); Pravin Prabhu, Morgan Hill, CA (US)

Correspondence Address: CARR & FERRELL LLP, 2225 EAST BAYSHORE ROAD, SUITE 200, PALO ALTO, CA, 94303, US

(21) Appl. No.: 09/740,749

(22) Filed: Dec. 18, 2000

(51) Int. Cl. G11B 5/60; G11B 21/20

(52) U.S. Cl. 360/122; 360/235.7; 360/236.5; 204/192.34

(57) ABSTRACT

The present invention provides a read/write head for use in a hard disk drive system. The head includes a self-adjusting sacrificial pad constructed of a material relatively softer than the recording medium of the recording system. The pad, present on an air-bearing surface of the head, generates an area of negative pressure, which acts to pull the head toward a magnetic disk of the disk drive system. Upon contact with certain asperities in the generally smooth surface of disk, the sacrificial pad wears down. As the pad wears, the negative pressure created by the pad decreases, allowing the head to fly further from the disk until there is no more contact with the disk. In this way the head of the present invention flies as close as possible to the disk. The sacrificial pad also acts to protect the read and write elements of the head.

### FIELD OF THE INVENTION

The present invention relates to magnetic read/write heads for use in data recording and retrieval devices and more particularly to a head having a self adjusting air bearing surface allowing extremely low fly height.

### BACKGROUND OF THE INVENTION

Magnetic disk drives are used to store and retrieve data for digital electronic apparatus such as computers. In FIGS. 1A and 1B, a magnetic disk data storage system 10 of the prior art includes a sealed enclosure 12, a disk drive motor 14, one or more magnetic disks 16, supported for rotation by a drive spindle 18 of motor 14, and an actuator 20 including at least one arm 22, the actuator being attached to a pivot bearing 24. Suspensions 26 are coupled to the ends of the arms 22, and each suspension supports at its distal end a read/write head 28. The head 28 (which will be described in greater detail with reference to FIGS. 2A and 2B) typically includes an inductive write element and a sensor read element. As the motor 14 rotates the magnetic disk 16, as indicated by the arrow R, an air bearing is formed under the transducer 28 causing it to lift slightly off of the surface of the magnetic disk 16, or, as it is termed in the art, to “fly” above the magnetic disk 16. Various magnetic “tracks” of information can be written to and/or read from the magnetic disk 16 as the actuator 20 causes the head 28 to pivot in a short arc across a surface of the disk 16. The pivotal position of the actuator 20 is controlled by a voice coil 30, which passes between a set of magnets (not shown) to be driven by magnetic forces caused by current flowing through the voice coil 30.

With reference now to FIG. 2A, the head 28 is held to the suspension by a gimbal 32. The write element 29 and read element are 31 are disposed at an end of the head 28. During operation, the disk 16 moves beneath the head 28 as indicated by arrow 34. The disk 16 is constructed of a polished aluminum or glass substrate, a NiP layer, and a magnetic layer. The disk undergoes a polishing process to generate a smooth upper surface 36. However, no matter how effective the polishing, the surface cannot achieve perfect, absolute smoothness. A certain amount of surface roughness will remain, and certain asperities 38 will be found to project upward from the surface 36. The surface 36 of the disk 16 is protected by an overcoat 40, which protects the disk from corrosion and wear damage. The disk 16 is also protected by thin lubrication layer 42.

As the disk 16 moves past the head 28, frictional forces on air adjacent to the disk 16 cause the air to move under the head 28 as indicated by arrows 44. This airflow generates aerodynamic forces, which lift the head to allow it to fly over the disk 16. As mentioned earlier, certain asperities 38 rise from the surface of the disk 16. If the head were to hit one of the asperities 38 passing thereby, such contact would be problematic for several reasons. First, contact with the asperity 38 would create friction, generating heat in the read sensor 31. This heat would be mistakenly read as a data signal by the read element. Such erroneous signals are known in the art as thermal asperities. Secondly, contact with the asperity would remove the protective layer 40, exposing the disk 16 to corrosion damage. Also, contact with the asperity risks physical damage to the read and write elements 31, 29. This risk is exacerbated by the fact that the read and write elements are generally located on the head 28 at a point closest to the disk 16, as illustrated in FIG. 2A.

Contact with asperities 38 has previously been avoided by designing the heads 28 to fly at an altitude significantly above the highest of the asperities 38. Flying characteristics of the head 28 can be controlled to a great extent by the configuration of the air bearing surface 46, that is the surface of the head 28 closest to the disk 16 during use. With reference to FIG. 2B, the air bearing surface 46 can include rails 48 as well as other shapes, which affect the pressure profile under the head 28. The end of the head 28 facing toward the oncoming direction of the airflow is called the leading edge 50, while the opposite end is called the trailing edge or aft end 52. Air flowing over the rails 48 generates a high-pressure area at the front end 54 of the rail 48 closest to the leading edge. By controlling the configuration of the rail, the flight of the head can be controlled.

Although maintaining a high fly height can effectively prevent contact with the disk surface 36, in order to increase data density it becomes increasingly important to design a head that will position the read and write elements 29, 31 as close as possible to the surface 36 of the head 28. Higher data density requires smaller read and write patterns, which corresponds to generally smaller signal strength. This correspondence is geometrically related to flying height. In addition, increasing the number of signal pulses in a given inch of signal track, leads to a decrease in the amplitude of the signal.

Therefore, there remains a need for a head that can fly as close as possible to a disk surface while mitigating the effects of contact with asperities in the disk surface. Such a head design would preferably facilitate a very stable fly height necessary for such low flight. Additionally, such a design would prevent damage to the read and write elements, should such contact occur, and would mitigate the effects of thermal asperities caused by such contact.

### SUMMARY OF THE INVENTION

The present invention provides a magnetic read/write head for use in a magnetic data recording and retrieval system, having the ability to fly at a very low height over a recording medium. The head includes a generally block shaped substrate having a front end and a back end and an air bearing surface extending from the front end to the back end. Read and write elements are disposed in the head so as to be held in close proximity to the recording medium passing thereby. A sacrificial pad is provided on the air-bearing surface and is constructed of a material that is relatively softer than the media surface.

The pad can be formed to have a rearward opening cavity, that is, the pad can be configured as a “U” or horseshoe shape opening toward the back end of the substrate. This cavity creates a negative pressure area during use, which draws the head toward the passing recording medium. The amount of negative pressure provided by the cavity is proportional to the thickness of the pad. Any contact between the recording medium and the pad will cause the pad to wear down, which in turn will decrease the negative pressure area. Therefore, as the pad contacts the recording medium and wears down, the head will fly slightly, progressively higher until no contact is made, at which point wear of the pad will cease and the head will maintain a stable fly height. In this way, the pad creates a self-limiting aerodynamic air bearing profile creating a very stable, very low flight profile, even at or below the media glide avalanche.

The sacrificial pad can be advantageously placed near the read and write elements to protect the elements from contact with any asperity which might extend from the recording medium passing thereby. The pad can be constructed of hematite, which has been found to exhibit excellent tribological properties. The pad could also be constructed of sputter deposited carbon, or some other relatively soft material.

The pad can be constructed to be small as compared with the head. For example, the pad could be roughly 50-100 μm by 50-100 μm, having an initial height that can vary from 2 nm to 8 nm, depending on the application, having a cavity of roughly 25-50 μm by 25-50 μm. In addition, the invention can include more than one such pad as dictated by design requirements.

These and other advantages of the present invention will become apparent to those skilled in the art upon a reading of the following descriptions of the invention and a study of the several figures of the drawings.

### BRIEF DESCRIPTION OF THE FIGURES

The present invention will be readily understood by the following detailed description in conjunction with the accompanying drawings, with like reference numerals designating like elements:

FIG. 1A is a partial cross-sectional front elevation view of a magnetic data storage system of the background art;

FIG. 1B is a top plan view taken along line 1B-1B of FIG. 1A;

FIG. 2A is a view taken from line 2A-2A of FIG. 1B, shown enlarged;

FIG. 2B is a view taken from line 2B-2B of FIG. 2A;

FIG. 3 is a perspective view showing an air bearing design of a read/write head embodying the present invention;

FIG. 4 is a view taken from line 4-4 of FIG. 3, rotated 90 degrees counter clockwise;

FIG. 5 is a view taken from circle 5 of FIG. 3, shown enlarged;

FIG. 6 is a view similar to that of FIG. 5, illustrating an alternate embodiment of the invention; and

FIG. 7 is a flowchart illustrating a method for constructing a head embodying the present invention.

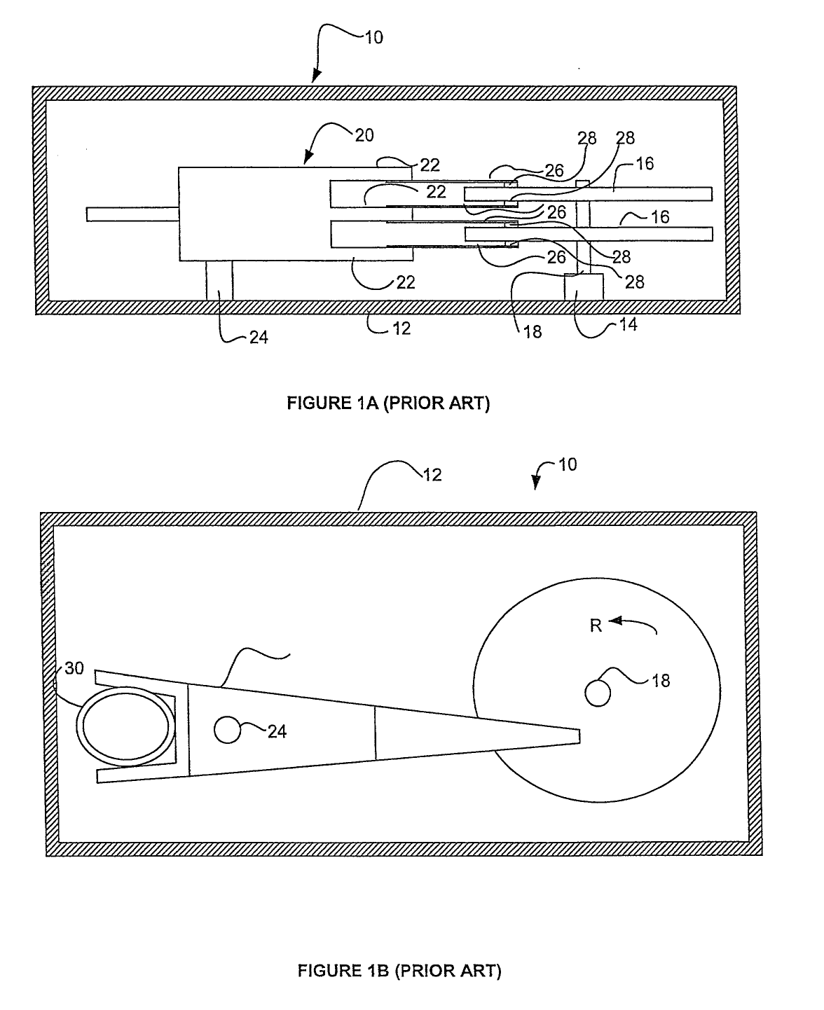

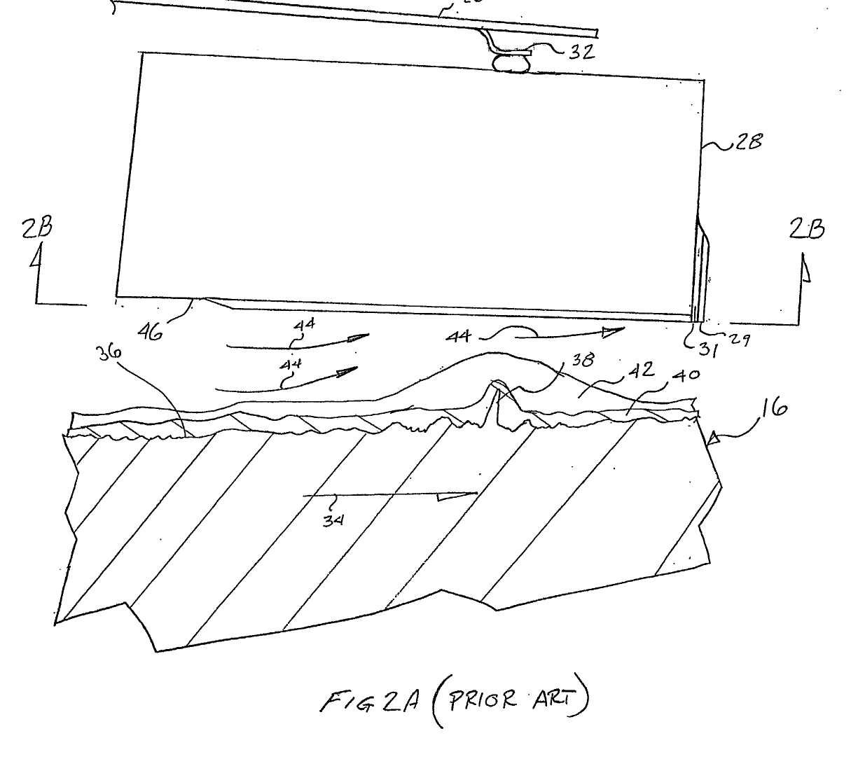

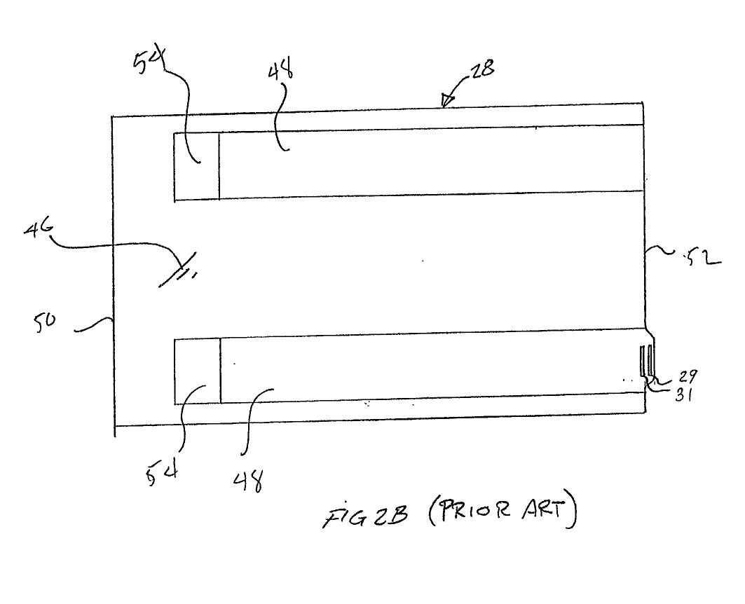

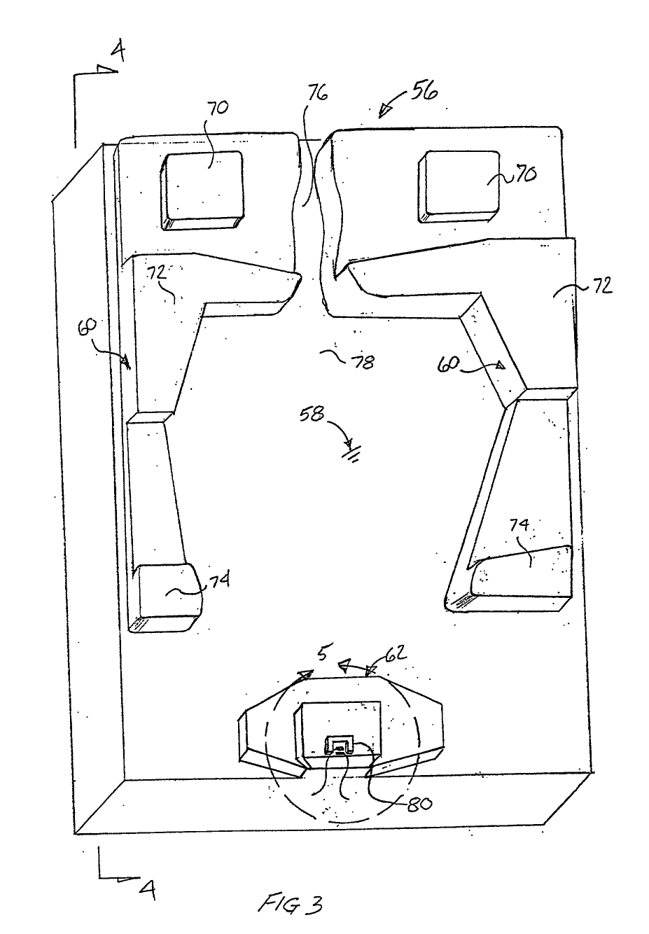

### DETAILED DESCRIPTION OF THE PREFERRED EMBODIMENTS

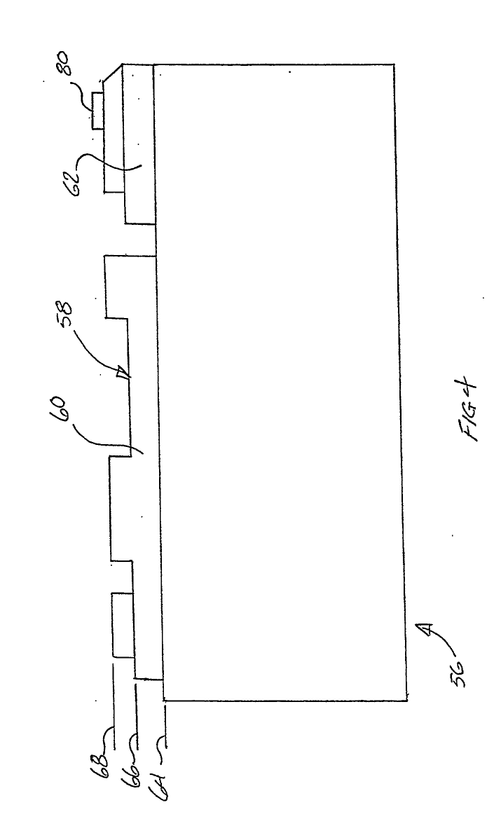

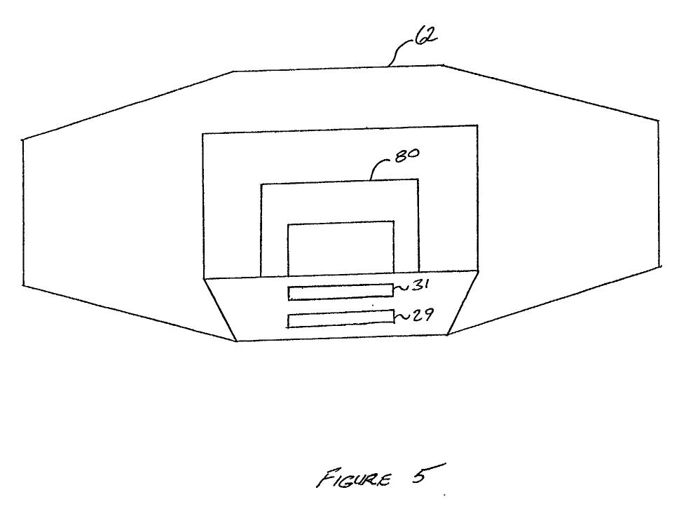

With reference to FIG. 3, the present invention includes a read/write head 56 having a new air bearing design feature that allows the head to fly at or below the media glide avalanche. This feature automatically adjusts flying height to a minimal contact height and at the same time protects the read and write elements from damage. The head 56 has an air bearing surface 58 that includes a pair laterally opposed rails 60 and a rear pad 62. With reference to FIG. 4, which shows a profile of the head, the topography of the air-bearing surface 58 consists basically of three levels, a base level 64, an intermediate level 66, and a raised level 68. These levels are generated by a series of masking and etching operations.

With reference again to FIG. 3, each of the rails 60 has a front pad 70, a larger central pad 72 and a rear pad 74. These pads are specifically shaped and located to promote stable flight characteristics. The front portions of the rails define a channel 76 there between, which opens to form a rear-opening cavity 78. The cavity creates a low-pressure area, centrally located on the air-bearing surface 58. Conversely, the various pads 70, 72, 74 and 62 generate high-pressure areas, especially at their leading edges. The centrally located high pressure area created by the cavity 58 acts in opposition to the peripherally located high pressure areas generated by the various pads. The opposition between high and low-pressure areas promotes a stable flight profile, preventing excessive roll, pitch, and yaw.

With continued reference to FIG. 3, the channel 76 formed between the rails 60 allows airflow there through. This airflow continually flushes out the cavity 58, preventing the accumulation of debris in the cavity 58. As will be appreciated by those skilled in the art of air bearing design, the pad 62 experiences higher pressure than any other area of the air bearing surface 58 and also is the lowest flying portion of the head 56. The pad 62 can be centrally located near the trailing edge of the air bearing surface 58 or can be located near one of the lateral sides of the air bearing surface 58 near the trailing edge. It is at this location that the read and write elements 29, 31 are located, placing them as close as possible to the passing recording medium.

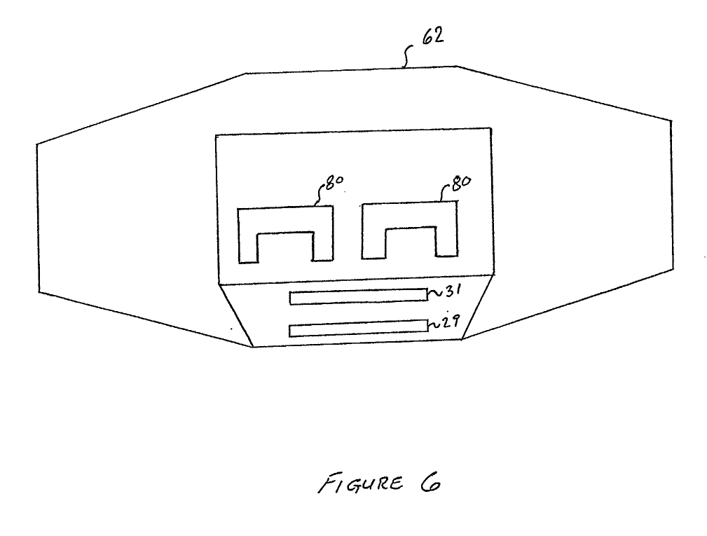

With reference still to FIG. 3, a sacrificial pad 80 extends from the rear pad 62 at the location of the read and write elements 29, 31. As can be seen more clearly with reference to FIG. 4, the sacrificial pad 80 extends higher than any other portion of the air bearing surface. FIG. 5 illustrates the sacrificial pad 80 in greater detail. The sacrificial pad 80 is generally “U” shaped, being reward opening. This configuration generates a negative pressure when the head 56 is in use. As can also be seen, the sacrificial pad acts as a guard to protect the read and write elements 31, 29 from contact with any asperities present in the passing magnetic disk 16.

The sacrificial pad 80 is preferably constructed of hematite. Hematite is an alpha phase Fe₂O₃ and has been found to exhibit excellent tribological properties. Hematite has a Vickers hardness of 900, making it about half as hard as the hard diamond like carbon of which the disk 16 is covered. This means that in the case of contact between the head 56 and the disk 16, the sacrificial pad will wear before the disk, thereby avoiding damage to the disk. Testing including drag tests has shown hematite to be a superior performer in head disk interface. Alternatively, the sacrificial pad 80 can also be constructed of sputter deposited carbon, which has also been found to wear first in head disk interface situations. Other suitable materials could also be use as a sacrificial pad, with primary design consideration being given to tribological properties in that the pad must be the first item to wear during contact with the disk 16.

As will be appreciated by those skilled in the art, the rearward opening configuration of the sacrificial pad generates a negative pressure that will be proportional to the thickness of the pad 80. The thicker the pad, the greater the negative pressure. Preferably, this negative pressure will be great enough to cause the pad 80 to contact asperities in the surface of the disk 16. This contact will tend to wear the pad 80, gradually decreasing the negative pressure generated thereby. As the negative pressure decreases with increasing wear, the head will tend to fly progressively higher from the surface of the disk 16. At some point the head 56 will fly just high enough that contact with the disk surface and wear will cease, at which point the head will maintain a steady fly height. In this way the pad provides a self-limiting process that allows the head 56 to fly at the lowest possible height without contacting the disk 16.

In a possible preferred embodiment of the invention, the sacrificial pad has outer dimensions of about 100 μm by 100 μm, and has a thickness that can range form 2 nm to 8 nm depending on the application requirements. The present invention can be used with data recording systems having start-stop designs wherein the head lands on the recording medium, as well as with load-unload start-stop designs that never land on the medium. The present invention allows fine control over flight profile, allowing heads 56 to be designed for flight in the range of 4-12 nm from the surface of a disk 16.

With reference now to FIG. 6, in an alternate embodiment of the invention, more than one (in this case two) sacrificial pads 80 are used. These pads 80 are preferably located symmetrically with respect to the read/write elements 29, 31 and still function to protect the elements 29, 31 from damage. In this embodiment the sacrificial pads 80 preferably have outer dimensions of 50μ by 50 μm, and each having an inner cavity of 25 μm by 25 μm with a thickness of roughly 3 nm.

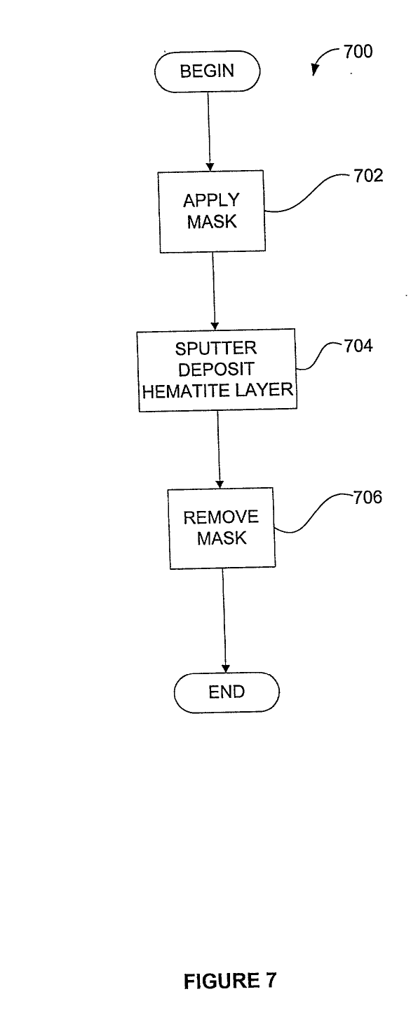

With reference to FIG. 7, a method 700 for constructing the sacrificial pad 80 will be described. First, in a step 702 a mask of photoresist material is deposited. The photoresist mask is formed in the pattern of the desired finished pad 80 by a photolithographic process familiar to those skilled in the art. Then, in a step 704 a layer of hematite is deposited. The hematite is preferably deposited by a sputtering process to the desired thickness of the finished pad 80. Finally, in a step 706 the mask is lifted of, revealing the formed pad 80.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. For example the size, shape and number of sacrificial pads used can be varied from those disclosed herein. In addition, materials other than those disclosed can be used to form a sacrificial pad.

What is claimed is:

1. A read/write head for use in a data recording and retrieval system, comprising:
a. a generally block shaped substrate having a front end, and back end and a surface extending from said front end to said back end;
b. a write element incorporated in said substrate and having a portion disposed toward said surface;
c. a read element incorporated in said substrate and having a portion disposed toward said surface; and
d. a sacrificial pad extending from said surface and constructed of a material that is comparatively softer than said substrate.

2. A read/write head as recited in claim 1 wherein said pad, said read element and said write element are co-located on said substrate.

3. A read/write head as recited in claim 1 wherein said pad is configured with a cavity opening toward said back end of said substrate.

4. A read/write head as recited in claim 1 wherein said pad can be at least partially worn during use, and wherein said pad includes a rearward opening negative pressure cavity which generates a negative pressure during use that decreases proportionally to said wear of said pad.

5. A read/write head as recited in claim 1 wherein said pad is constructed of hematite.

6. A read/write head as recited in claim 1 wherein said pad is constructed of carbon.

7. A read/write head as recited in claim 1 wherein said pad is constructed of sputter deposited carbon.

8. A read/write head as recited in claim 1 wherein said pad has a height of from 2 nm to 8 nm.

9. A read/write head as recited in claim 1 wherein said pad covers an area on said surface of roughly 100 μm by 100 μm.

10. A read/write head as recited in claim 1 wherein there are two or more of said pads.

11. A read/write head as recited in claim 10 wherein said two or more pads are disposed symmetrically with respect to said read and write elements.

12. A data storage and retrieval apparatus for use with a computer system, comprising:
a. an enclosure;
b. a motor having a spindle and mounted in said enclosure;
c. a magnetic disk, supported by said spindle for revolution thereabout;
d. an actuator, pivotally connected with said spindle;
e. a head supported by said actuator for arcuate movement adjacent to a surface of said magnetic disk, said disk having a forward end facing into the direction from which said revolving disk approaches and having an opposite aft end;
f. a read element disposed on said head;
g. a write element disposed on said head;
h. an air bearing surface formed on said head adjacent said disk; and
i. a pad extending from said air-bearing surface, said pad being constructed of a material softer than both of said head and said disk and formed with a cavity opening toward the aft end of said head.

13. An apparatus as recited in claim 12 wherein a portion of said read element and said write element are disposed at said air bearing surface and wherein said pad is disposed at the location of said read and write elements.

14. An apparatus as recited in claim 12 wherein said head includes two or more pads disposed on said air bearing surface.

15. An apparatus as recited in claim 13 wherein said two or more pads are disposed symmetrically relative to said read and write elements.

16. A method for manufacturing a head for use in a computer disk drive system, the head having a self adjusting air-bearing design for maintaining a low and stable fly height, the method comprising the steps of:
a. providing a substrate having a surface thereon defining an air-bearing surface;
b. patterning a mask onto said relatively soft material;
c. depositing a layer of relatively soft material onto said air-bearing surface; and
d. removing said mask.

17. A method for manufacturing a head as recited in claim 16, wherein said deposited layer of relatively soft material is hematite deposited by a sputter deposition process.

18. A method for manufacturing a head as recited in claim 16, wherein said deposited layer of relatively soft material is carbon deposited by a sputter deposition process.

19. A method for manufacturing a head as recited in claim 16, wherein said deposited layer of relatively soft material is relatively soft as compared with a magnetic recording medium of said disk drive system.

20. A method for manufacturing a head as recited in claim 16 wherein said mask is patterned in a “U” shape.
